(19) United States
(12) Patent Application Publication
(10) Pub. No.: US 2026/0351902 A1
(43) Pub. Date: Nov. 5, 2026

(54) CONNECTOR POSITION ASSURANCE STATE INDICATOR

(71) Applicant: Molex, LLC, Lisle, IL (US)

(72) Inventor: Kumar Manish Tiwari, Bengaluru (IN)

(21) Appl. No.: 19/661,773

(22) Filed: Apr. 29, 2026

(30) Foreign Application Priority Data
May 2, 2025 (IN) 202541042753

(51) Int. Cl. H01R 13/641; H01R 13/631

(52) U.S. Cl. CPC H01R 13/641; H01R 13/631; H01R 2201/26

(57) ABSTRACT

A connector position assurance (CPA) component of a connector is disclosed. The connector includes a housing extending in an axial direction from a cable end to an engagement end. The CPA component is arranged in the housing and extends in the axial direction from a locking end, closest to the engagement end of the housing, to an actuation end, closest to the cable end of the housing. A region of the CPA component extending from the locking end to the actuation end includes one or more indication elements, and fewer of the one or more indication elements are visible in a locked position of the CPA component than in an unlocked position of the CPA component.

### BACKGROUND

Connectors facilitate data and/or power transfer between devices. For example, a peripheral device may be connected to a computer or other host (e.g., camera) to facilitate data transfer to or from the peripheral device. Power may be delivered to the peripheral device through the connection, as well. For example, a cable from the peripheral device (e.g., keyboard, mouse, external hard drive) may terminate at a connector that can couple to a corresponding connector of the computer. As another example, the host device may be in the form of an electronic control unit (ECU) of a vehicle, and the peripheral device may be part of the infotainment system.

While some connectors are simply pushed into and pulled out of the receptacle of the host, others may include a mechanism (e.g., latch, lever) that prevents simply pulling the connector to disengage the peripheral device from the host. Some connectors may include a component for connector position assurance (CPA).

### BRIEF SUMMARY OF THE INVENTION

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Various embodiments are disclosed for a connector with a connection position assurance state indicator. An example connector includes a housing extending in an axial direction from a cable end to an engagement end, and a connector position assurance (CPA) component arranged in the housing and extending in the axial direction from a locking end, closest to the engagement end of the housing, to an actuation end, closest to the cable end of the housing. A region of the CPA component includes one or more indication elements, and fewer of the one or more indication elements are visible in a locked position of the CPA component than in an unlocked position of the CPA component.

In some aspects, a portion of the region of the CPA component is positioned under a portion of the housing. The portion of the region of the CPA component positioned under the portion of the housing may be obscured from view and not visible. The portion of the region of the CPA component positioned under the portion of the housing may include at least one of the one or more indication elements when the CPA component is in the locked position.

In some aspects, the portion of the region of the CPA component positioned under the portion of the housing is a first portion when the CPA component is in the unlocked position. In some aspects, the portion of the region of the CPA component positioned under the portion of the housing is a second portion when the CPA component is in the locked position. The portion of the region of the CPA component positioned under the portion of the housing may be changed from the first portion of the region to the second portion of the region based on force applied at the actuation end of the CPA component toward the engagement end of the housing. The portion of the region of the CPA component positioned under the portion of the housing may changed from the second portion of the region to the first portion of the region based on force applied at the actuation end of the CPA component toward the cable end of the housing.

In some aspects, the region of the CPA component includes two indication elements that are visible in the unlocked position of the CPA component, and only one of the two indication elements is visible in the locked position of the CPA component. The one or more indication elements may include letters, numbers, or symbols.

An example connector position assurance (CPA) component in a connector includes a first subregion including one or more indication elements that are visible in an unlocked position and obscured from view in a locked position of the CPA component; and a second subregion that is visible in both the unlocked position and the locked position of the CPA component.

In some aspects, the one or more indication elements of the first subregion may include letters, numbers, symbols, or a combination. The second subregion may include one or more indication elements. The one or more indication elements of the second subregion may include letters, numbers, symbols, or a combination. In some aspects, in the locked position, the CPA component is configured to lock the connector and a second connector in a mated position. The CPA component may include one or more locking features to lock the connector and the second connector in the mated position in the locked position of the CPA component.

In some aspects, the CPA component may include a tab to be operated to transition the one or more locking features of the CPA component between the unlocked position and the locked position. The one or more indication elements of the first subregion may be obscured by a housing of the connector when the CPA component is in the locked position. The CPA component may include attachment features that retain the CPA component in a housing of the connector. In some aspects, the first subregion of the CPA component includes one indication element and the second subregion of the CPA component includes one indication element.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a plan view of a connector and a connector position assurance (CPA) component with a CPA state indicator according to various embodiments of the present disclosure.

FIG. 2 is a plan view of the connector of FIG. 1 coupled to another connector.

FIG. 3A is a perspective view of aspects of a connector with a CPA component in an unlocked state according to various embodiments of the present disclosure.

FIG. 3B is a perspective view of aspects of the connector of FIG. 3A with the CPA component in a locked state.

FIG. 4 is a perspective view of an exemplary CPA component with a CPA state indicator according to various embodiments of the present disclosure.

FIG. 5A is an exemplary region of a CPA component with numerical indication elements according to various embodiments of the present disclosure.

FIG. 5B is an exemplary region of a CPA component with a symbolic indication element according to various embodiments of the present disclosure.

FIG. 5C is an exemplary region of a CPA component with indication elements of different types according to various embodiments of the present disclosure.

### DETAILED DESCRIPTION

As previously noted, connectors may be used to interconnect devices (e.g., a peripheral device to a vehicle ECU). As also noted, some connectors may have a primary mechanism (e.g., latch, lever) to lock a connector in the engaged state, and some connectors may additionally or alternately have a CPA component. The CPA component may impose a locking/unlocking step that may be additional to the locking/unlocking via the latch, lever, or other primary mechanism. The CPA component may have an unlocked position in which the connector may be disengaged from the receptacle using only the primary mechanism and a locked position in which the connector is prevented from disengaging from the receptacle.

Ensuring that the CPA component is in the locked position may be important in many applications as a proxy for proper connection between the devices. Thus, for example, during diagnosis of an issue with functionality of a peripheral, quick verification of the CPA component state may expedite determining whether the issue may stem from an improper connection rather than a malfunction.

In the context outlined above, aspects of a CPA state indicator are described. The CPA state indicator may refer to a region of the CPA component according to various embodiments. The region of the CPA component may include one or more indication elements (e.g., letters, numbers, symbols, or a combination). The region may be positioned such that fewer of the indication elements are visible when the CPA component is in the locked position than when the CPA component is in the unlocked position. Additionally or alternately, one or more indication elements may be fully visible when the CPA component is in the unlocked position and partially visible when the CPA component is in the locked position. Thus, viewing which, if any, indication elements are visible may provide a straightforward indication of the state of the CPA component as being locked or unlocked.

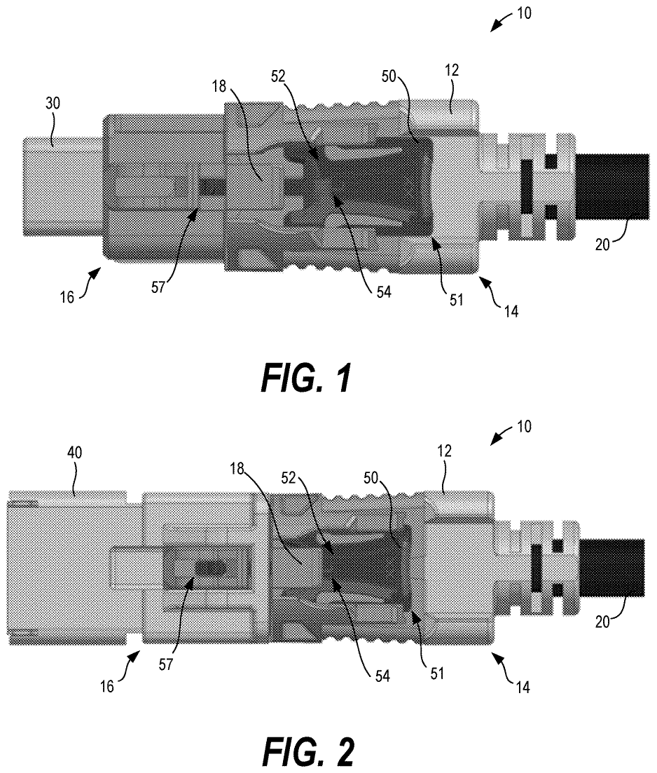

Turning to the drawings, FIG. 1 is a plan view of a connector 10 according to various embodiments of the present disclosure. The connector 10 has a housing 12 that extends in an axial direction from a cable end 14, at which a cable 20 extends from a peripheral device, for example, to an engagement end 16, at which the connector 10 engages with another connector 40, as shown in FIG. 2. A plug 30 is shown extending from the engagement end 16. The plug 30 may include connection pins surrounded by a shield. This plug 30 may be inserted in a receptacle of the other connector 40 during engagement.

A CPA component 50 is shown attached to the housing 12 of the connector 10. The CPA component 50 extends in the axial direction from an actuation end, which is the end of the CPA component 50 that is closest to the cable end 14 of the housing 12, to a locking end 57, which is the end closest to the engagement end 16 of the housing 12. The CPA component 50 is in the unlocked state as shown in FIG. 1. The CPA component 50 may include a state indicator in the form of a region 52 of the CPA component 50 that includes one or more indication elements 54. The exemplary CPA component 50 of FIG. 1 is shown with two indication elements 54, in the form of the letters “U” and “L,” in a region 52. The region 52 can include some or all of a side of the CPA component 50 that is visible in FIG. 1. The letters “XX” on the same side of the CPA component 50 as the “U” and “L” may also be considered indication elements 54.

In additional or alternate embodiments, further discussed with reference to FIGS. 5A-5C, there may be only one indication element 54 or more than two indication elements 54. In addition, an indication element 54 may be a letter, number, or symbol of any shape, and any combination of those may be in the region 52. A portion 18 of the connector housing 12 is indicated. As discussed with reference to FIG. 2, the portion 18 of the housing 12 may obscure one or more indication elements 54 when the CPA component 50 is in the locked state.

FIG. 2 is a plan view of the connector 10 of FIG. 1, shown engaged to another connector 40. The CPA component 50 is shown in the locked state in FIG. 2. As a comparison of FIGS. 1 and 2 shows, one of the two indication elements 54 of the exemplary CPA component 50, the “U” in the exemplary case, is obscured from view by the portion 18 of the housing 12. That is, in the locked state (e.g., in FIG. 2), fewer of the indication elements 54 are visible than in the unlocked state of the CPA component 50 (e.g., FIG. 1).

The position of the portion 18 of the housing 12 is unchanged in FIGS. 1 and 2. That is, the portion 18 of the housing 12 is a fixed element, at least in the axial direction of the housing 12. The CPA component 50 is shifted toward the engagement end 16 of the housing 12 to put the CPA component 50 in the locked state, shown in FIG. 2, relative to its position in the unlocked state shown in FIG. 1. Thus, the locking end 57 of the CPA component 50 is closer to the engagement end 16 of the housing 12 in FIG. 2 (i.e., in the locked state) than in FIG. 1 (i.e., in the unlocked state). This shift in the position of the CPA component 50 relative to the position of the housing 12, including the portion 18 of the housing 12, results in one or more indication elements 54 that are visible in the unlocked position of the CPA component 50 becoming obscured in the locked position of the CPA component 50.

In alternate embodiments, the shape of the CPA component 50 may be different, and the movement of the CPA component 50 relative to the housing 12 of the connector 10 to transition to the locked state may be different. Regardless of any difference in the shape and/or arrangement of the CPA component 50, a movement of the CPA component 50 into the locked state results in fewer indication elements 54 being visible.

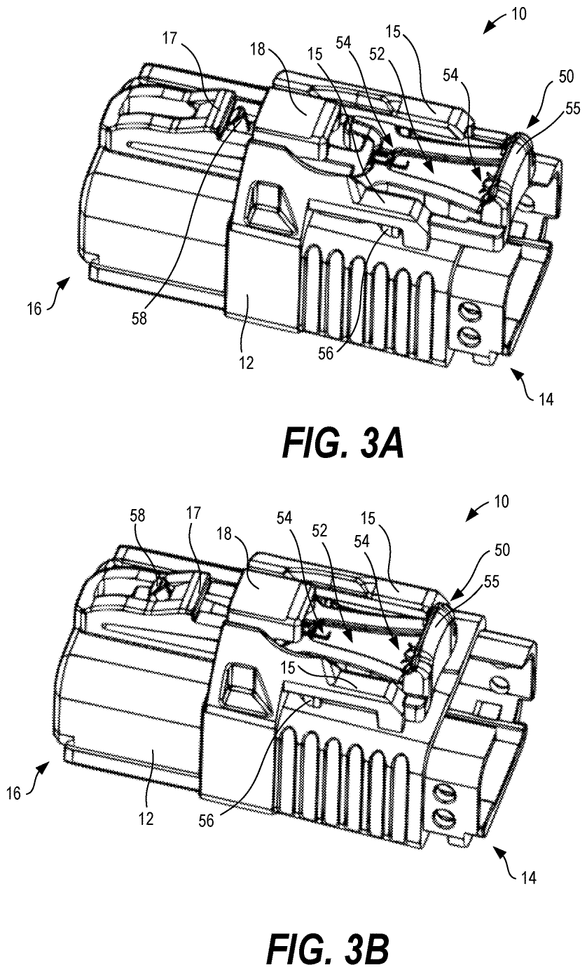

FIG. 3A is a perspective view of aspects of a connector 10 with a CPA component 50 in an unlocked state according to various embodiments of the present disclosure. FIG. 3B is a perspective view of aspects of the connector 10 of FIG. 3A with the CPA component 50 in a locked state. A tab 55 of the CPA component 50 may be operated (i.e., moved) to transition the CPA component 50 between the unlocked and locked states.

An attachment feature 56 of the CPA component 50 is visible below a holding bar 15 that is part of the housing 12 of the connector 10. The attachment feature 56 is shaped and positioned under the holding bar 15 to prevent pulling the CPA component 50 up or sliding the CPA component 50 out of the connector 10. That is, the horizontal portion of the holding bar 15 prevents the CPA component 50 from being picked up, according to the orientation shown in FIG. 3A, to be separated from the housing 12. In addition, the vertical portion of the holding bar 15 prevents the attachment feature 56 from being slid toward the cable end 14 of the housing 12, past the holding bar 15. The holding bar 15 does facilitate movement of the attachment feature 56 toward the engagement end 16 to transition the CPA component 50 to the locking position, as shown by the transition in the position of the attachment feature 56 from FIG. 3A to FIG. 3B.

A locking feature 58 of the CPA component 50 is also visible. In the unlocked state shown in FIG. 3A, the locking feature 58 is closer to the cable end 14 of the housing 12 than a locking bar 17 of the housing 12. In the locked state shown in FIG. 3B, the locking bar 17 of the housing 12 is closer to the cable end 14 of the housing 12 than the locking feature 58. From the position shown in FIG. 3A, the CPA component 50 is moved (e.g., by pushing the tab 55) toward the engagement end 16 of the housing 12 to transition the CPA component 50 to the locked state shown in FIG. 3B. This movement forces the locking feature 58 to slide under and past the locking bar 17 of the housing 12 to its position in FIG. 3B. As previously noted, this movement places a part of the region 52 (subregion 52a in FIGS. 5A-5C) including one or more indication elements 54 below the portion 18 of the housing 12. As also noted, the specific movement of the CPA component 50 and the position of the portion 18 of the housing 12 that obscures a part of the region 52 including one or more indication elements 54 may be different according to different embodiments. In addition, alternate CPA components 50 may include two or more locking features 58.

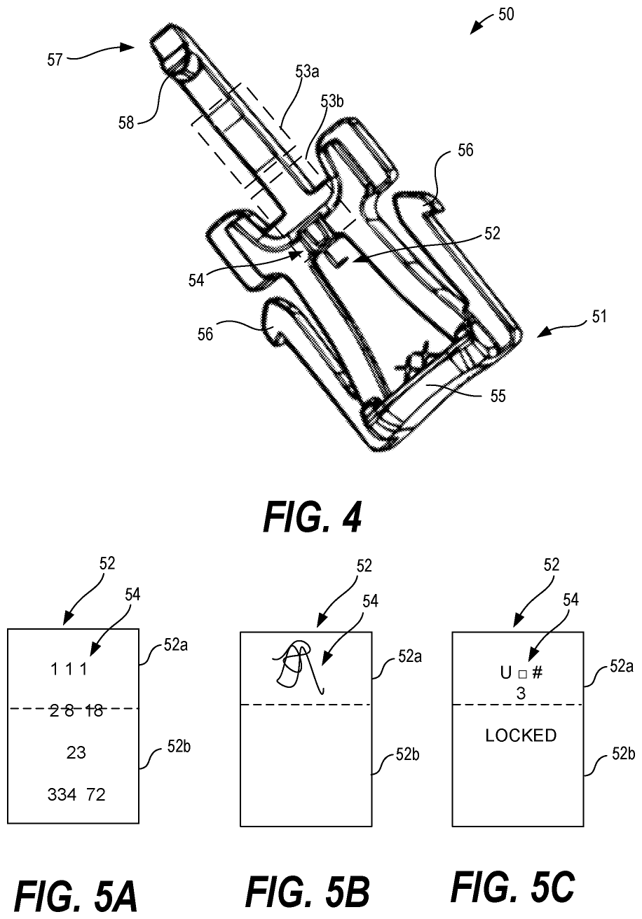

FIG. 4 is a perspective view of an exemplary CPA component 50 with a CPA state indicator according to various embodiments of the present disclosure. The CPA component 50 extends from an actuation end 51 that includes a tab 55 to a locking end 57. The locking feature 58 near the locking end 57 and two attachment features 56 on opposite sides of the exemplary CPA component 50 are shown in FIG. 4. CPA state indication is accomplished through one or more indication elements 54 in a region 52 of the CPA component 50. In the exemplary CPA component 50, the region 52 is a side or surface region of the CPA component 50. The region 52 may have multiple surfaces at different levels in a depth direction, as in the exemplary case.

A first portion 53a and a second portion 53b are indicated by dashed rectangles in FIG. 4. The first portion 53a is obscured from view by the portion 18 of the housing 12, as shown in FIG. 1, when the exemplary CPA component 50 is in the unlocked position. The second portion 53b is obscured from view by the portion 18 of the housing 12, as shown in FIG. 2, when the exemplary CPA component 50 is in the locked position. Thus, one of the indication elements 54, the “U” in the exemplary illustration, is obscured when the CPA component 50 of FIG. 4 is in the locked position in the housing 12 of the connector 10.

FIGS. 5A, 5B, and 5C illustrate different numbers and types of indication elements 54. Each of the figures includes a dashed line used to separate a first subregion 52a, which is obscured from view in the locked position of the CPA component 50, and a second subregion 52b, which is visible in both the locked and unlocked states of the CPA component 50. FIG. 5A is an exemplary region 52 of a CPA component 50 with numerical indication elements 54 according to various embodiments of the present disclosure. The exemplary region 52 in FIG. 5A shows that the indication elements 54 may be numbers rather than letters, as shown for the CPA component 50 in FIG. 4 and the previous figures. In the exemplary case shown in FIG. 5A, the “1 1 1” in the first subregion 52a is obscured by the portion 18 of the housing 12 when the CPA component 50 is in the locked state. The “2 3 18” straddles the first subregion 52a and the second subregion 52b (i.e., is on the dashed line in FIG. 5A) and is partly obscured in the locked state of the CPA component 50.

FIG. 5B is an exemplary region 52 of a CPA component 50 with a symbolic indication element 54 according to various embodiments of the present disclosure. A dashed line is again used to separate the first subregion 52a from the second subregion 52b according to the exemplary position and movement of the region 52 in the CPA component 50 shown in FIG. 4. The exemplary first subregion 52a in FIG. 5B illustrates a symbol as the indication element 54. The example also shows that no indication elements 54 may be visible when the CPA component 50 is in the locked state. That is, the exemplary region 52 of FIG. 5B only has one indication element 54 in the first subregion 52a (obscured by the portion 18 of the housing 12 in the locked state) and no indication elements 54 in the second subregion 52b (visible in both the unlocked and locked states of the CPA component 50).

FIG. 5C is an exemplary region 52 of a CPA component 50 with indication elements 54 of different types according to various embodiments of the present disclosure. A dashed line is again used to separate the first subregion 52a from the second subregion 52b according to the exemplary position and movement of the region 52 in the CPA component 50 shown in FIG. 4. The exemplary region 52 in FIG. 5C illustrates that the indication elements 54 may be a combination of letters, numbers, and/or symbols. In the example, the letters spelling “LOCKED” (shown in the second subregion 52b) would be the only indication elements 54 visible in the locked state of the CPA component 50.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A connector comprising:
a housing extending in an axial direction from a cable end to an engagement end; and
a connector position assurance (CPA) component arranged in the housing and extending in the axial direction from a locking end, closest to the engagement end of the housing, to an actuation end, closest to the cable end of the housing, wherein
a region of the CPA component includes one or more indication elements, and
fewer of the one or more indication elements are visible in a locked position of the CPA component than in an unlocked position of the CPA component.

2. The connector according to claim 1, wherein a portion of the region of the CPA component is positioned under a portion of the housing.

3. The connector according to claim 2, wherein the portion of the region of the CPA component positioned under the portion of the housing is obscured from view and not visible.

4. The connector according to claim 3, wherein the portion of the region of the CPA component positioned under the portion of the housing includes at least one of the one or more indication elements when the CPA component is in the locked position.

5. The connector according to claim 2, wherein the portion of the region of the CPA component positioned under the portion of the housing is a first portion when the CPA component is in the unlocked position.

6. The connector according to claim 5, wherein the portion of the region of the CPA component positioned under the portion of the housing is a second portion when the CPA component is in the locked position.

7. The connector according to claim 6, wherein the portion of the region of the CPA component positioned under the portion of the housing is changed from the first portion of the region to the second portion of the region based on force applied at the actuation end of the CPA component toward the engagement end of the housing.

8. The connector according to claim 6, wherein the portion of the region of the CPA component positioned under the portion of the housing is changed from the second portion of the region to the first portion of the region based on force applied at the actuation end of the CPA component toward the cable end of the housing.

9. The connector according to claim 1, wherein
the region of the CPA component includes two indication elements that are visible in the unlocked position of the CPA component, and
only one of the two indication elements is visible in the locked position of the CPA component.

10. The connector according to claim 1, wherein the one or more indication elements comprise letters, numbers, or symbols.

11. A connector position assurance (CPA) component in a connector, the CPA component comprising:
a first subregion including one or more indication elements that are visible in an unlocked position and obscured from view in a locked position of the CPA component; and
a second subregion that is visible in both the unlocked position and the locked position of the CPA component.

12. The CPA component according to claim 11, wherein the one or more indication elements of the first subregion comprise letters, numbers, symbols, or a combination.

13. The CPA component according to claim 11, wherein the second subregion includes one or more indication elements.

14. The CPA component according to claim 13, wherein the one or more indication elements of the second subregion comprise letters, numbers, symbols, or a combination.

15. The CPA component according to claim 11, wherein, in the locked position, the CPA component is configured to lock the connector and a second connector in a mated position.

16. The CPA component according to claim 15, wherein the CPA component includes one or more locking features configured to lock the connector and the second connector in the mated position in the locked position of the CPA component.

17. The CPA component according to claim 16, wherein the CPA component includes a tab configured to be operated to transition the one or more locking features of the CPA component between the unlocked position and the locked position.

18. The CPA component according to claim 11, wherein the one or more indication elements of the first subregion are obscured by a housing of the connector when the CPA component is in the locked position.

19. The CPA component according to claim 11, wherein the CPA component includes attachment features that retain the CPA component in a housing of the connector.

20. The CPA component according to claim 11, wherein the first subregion of the CPA component includes one indication element and the second subregion of the CPA component includes one indication element.
